(19) United States
(12) Patent Application Publication
(10) Pub. No.: US 2011/0219424 A1
(43) Pub. Date: Sep. 8, 2011

(54) INFORMATION PROTECTION USING ZONES

(75) Inventors: Anatoliy Panasyuk, Bellevue, WA (US); Girish Bablani, Bellevue, WA (US); Charles McColgan, Kirkland, WA (US); Krishna Kumar Parthasarathy, Sammamish, WA (US)

(73) Assignee: Microsoft Corporation, Redmond, WA (US)

(21) Appl. No.: 12/718,843

(22) Filed: Mar. 5, 2010

(51) Int. Cl. G06F 21/00; G06F 15/16

(52) U.S. Cl. 726/1; 709/217

(57) ABSTRACT

Some embodiments are directed to an information protection scheme in which devices, users, and domains in an information space may be grouped into zones. When information is transferred across a zone boundary, information protection rules may be applied to determine whether the transfer should be permitted or blocked, and/or whether any other policy actions should be taken (e.g., requiring encryption, prompting the user for confirmation of the intended transfer, or some other action).

### BACKGROUND

Within an organization, information is frequently created and shared. For example, workers create and send e-mails both to other workers in the organization and people outside of the organization. In addition, workers create documents, upload these documents to internal file servers, transfer them to portable storage media (e.g., removable flash memory drives), and send them to other users outside of the organization.

Some of the information created by workers in an organization may be confidential or sensitive. Thus, it may be desired to allow workers in possession of such information to only share it with those authorized to access it and/or to reduce the risk of workers accidentally transferring such information to someone who is not authorized to access it.

### SUMMARY

The inventors have recognized that when information is shared, it may sometimes be sent to someone not authorized or not intended to have access to it or may be maliciously intercepted by someone not authorized to access it.

Thus, some embodiments are directed to an information protection scheme in which devices, users, and domains in an information space may be grouped into zones. When information is transferred across a zone boundary, information protection rules may be applied to determine whether the transfer should be permitted or blocked, and/or whether any other policy actions should be taken (e.g., requiring encryption, prompting the user for confirmation of the intended transfer, or some other action).

One embodiment is directed to a method for information protection performed by a computer comprising at least one processor and at least one tangible memory, the computer operating in an information space comprising a plurality of zones of users, devices, and/or domains, wherein each of the plurality of zones is a logical grouping of users, devices, and/or domains, and wherein the method comprises: in response to initiation of a transfer of information, determining whether the transfer of information would cause the information to cross a zone boundary between two of the plurality of zones; when it is determined that the transfer would not cause the information to cross the zone boundary, permitting the transfer; when it is determined that the transfer would cause the information to cross the zone boundary: accessing information protection rules; applying the information protection rules to the transfer to determine whether a policy action is to be performed; and when it is determined the policy action is to be performed, performing the policy action.

Another embodiment is directed to at least one computer readable medium encoded with instructions that when executed on a computer comprising at least one processor and at least one tangible memory, perform a method in an information space comprising a plurality of zones of users, device, and/or domains, wherein each of the plurality of zones is a logical grouping of users, devices, and/or domains, wherein the computer is grouped into one of the plurality of zones, the method comprising: creating a document at the computer; automatically determining a first classification for the document; embedding information identifying the determined first classification into the document; receiving user input identifying a second classification for the document; in response to the user input, overriding the first classification with the second classification by removing the information identifying the first classification from the document and embedding information identifying the second classification into the document.

A further embodiment is directed to a computer in a computer system comprising: at least one tangible memory; and at least one hardware processor that executes processor-executable instructions to: in response to user input of first information that groups users, devices, and/or domains into logical zones, storing the first information in the at least one tangible memory; in response to user input of second information specifying information protection rules to be applied in response to initiation of a transfer of information that would cause the information to cross a boundary between logical zones, storing the second information in the at least one tangible memory.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an information space logically divided into a plurality of zones, in accordance with some embodiments;

FIG. 2 is a block diagram of computer system in which information protection techniques of embodiments of the invention may be implemented;

FIG. 3 is a flow chart of a process for providing information protection in an information space logically divided into zones, in accordance with some embodiments; and

FIG. 4 is a block diagram of a computer system on which aspects of some embodiments may be implemented.

### DETAILED DESCRIPTION

The inventors have recognized that when workers in an organization create and/or access confidential or sensitive electronic information, situations may arise in which workers unwittingly or maliciously jeopardize the security of that information. For example, a worker may unintentionally send electronic information to someone who is not authorized to access that information or may store the electronic information in an insecure place (e.g., a file server which is accessible to someone unauthorized to access the information). As another example, a worker may share confidential electronic information in plain text (rather than encrypting it), thereby putting it at greater risk of being intercepted by someone not authorized to access it, or may take other actions that jeopardize the security of the information.

Thus, some embodiments are directed to a computer system in which users and devices are divided into logical groups called “zones.” When electronic information is transferred from a user or device in one zone to a user or device in another zone, the information is considered to have crossed a zone boundary. When a transfer of information is initiated that would cause the information to cross a zone boundary, information control rules may be applied to determine whether the transfer is permitted or whether some action is to be taken before the transfer is permitted (e.g., prompting the worker initiating the transfer, audit logging the transfer, requiring encryption of the information before allowing the transfer, or some other action).

In some embodiments, the information control rules may take into account the type of information that is being transferred. For example, different information control rules may be applied when attempting to transfer confidential information from a first zone to a second zone than when attempting to transfer non-confidential information from the first zone to the second zone. Thus, in some embodiments, when electronic information is generated, it may be tagged (e.g., automatically, semi-automatically, or manually) with a classification indicative of the sensitivity of the information and/or other properties of the information. The classification rules may take into account the classification of electronic information and the zone to which and from which the information is being transferred when the information is attempted to be transferred across a zone boundary.

This technique may provide a number of benefits. First, it allows one uniform security policy to be defined and applied across multiple different channels. That is, the same set of classification rules may be applied to transfer of e-mails, transfer of content through the world wide web, file transfer to a file server internal to the organization, and/or to any other type of electronic information or information channel. Second, it allows the information control rules to be customized based on the type of information to which the rules are applied so that a restrictive set of rules that might be warranted for sensitive or confidential information need not be applied to information for which such a restrictive set of rules is not warranted.

A number of problems with the prior art and a number of benefits provided by the above-discussed techniques are identified above. However, the invention is not limited to addressing any or all of these problems or providing any or all of these benefits. That is, while some embodiments may address some or all of these problems and provide some or all of these benefits, some embodiments may not address any of these problems or provide any of these benefits.

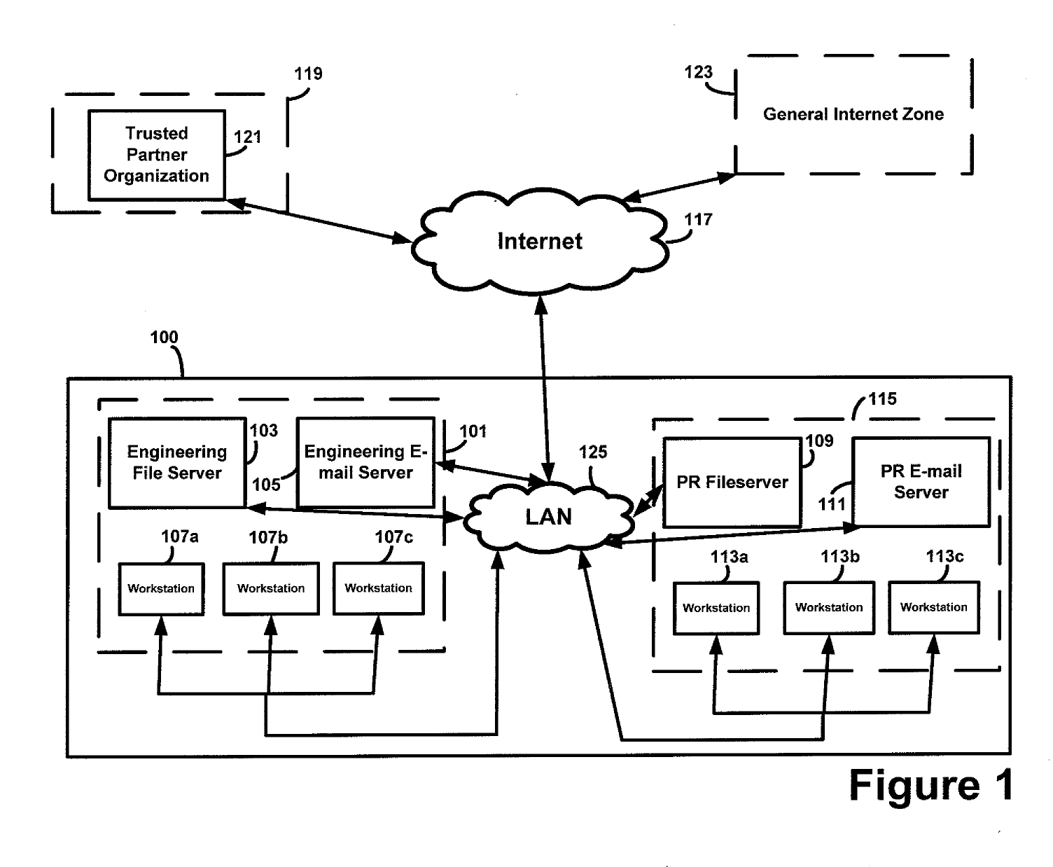

FIG. 1 shows an example of an information space that may be classified into zones. As shown in FIG. 1, an organization 100 may have a computer system comprising a number of devices. Some of these devices may be used by an engineering department of the organization and some may be used by a public relations department. Because documents or other pieces of content from the engineering department likely include a significant amount of confidential and/or sensitive information, while documents or other pieces of content generated in the public relations department are less likely to include such information, the devices used by the engineering department may be grouped into one zone and the devices used by the public relations department may be grouped into another zone. Thus, as shown in FIG. 1, though all the devices in the organization are physically connected via local area network (LAN) 125, engineering file server 103, engineering e-mail server 105, and workstations 107a, 107b, and 107c may be logically grouped in Engineering Department zone 101, while PR file server 109, PR e-mail server 111, and workstations 113a, 113b, and 113d are logically grouped together in PR Department Zone 115.

In addition, in the example of FIG. 1, an organization 121 that is external to organization 100 may be logically grouped into a zone. For example, if organization 121 is a trusted partner of organization 100, it may be desired to apply different information control rules to organization 121, such that information sent to and received from organization 121 (e.g., via Internet 117) is treated differently from that of other entities external to organization 100. Thus, organization 121 may be logically grouped into Trusted Partner zone 119, while information sent to and received from other entities external to organization 100 (e.g., via Internet 117) may be treated as being sent to and received from general Internet zone 123. As discussed above, when information is sent from one zone to another zone, information protection rules may be applied and action may be taken based on the information protection rules, if warranted.

In the example of FIG. 1, devices within organization 100 are logically grouped into two zones. It should be appreciated that this is merely illustrative as an organization may comprise any suitable number of zones. For example, all devices and users within an organization may be grouped into a single zone or these devices and users may be grouped into three or more different zones. In addition, in the example of FIG. 1, only devices are shown as being logically grouped into zones. However, users (e.g., employees of organization 100, other workers, or other persons) or domains may also be logically grouped into zones. For example, employees of organization 100 who work in the engineering department may be grouped into Engineering Department zone 101 and employees who work in the PR department may be grouped into PR Department zone 115.

As such, the inventors have recognized that a situation may arise where a user that is grouped into one zone is using a device that is grouped into a different zone. Thus, when the user sends information from or receives information at that device, the information may be treated as having been sent from or received at either the zone of the user or the zone of the device. Thus, for example, if an employee of the engineering department who is grouped into the Engineering Department zone logs in and works from workstation 113a, which is grouped in the PR Department zone, the employee may attempt to upload a document to engineering file server 103. This document may be treated as either being sent from the Engineering Department zone or the PR Department zone.

In some embodiments, the zone of the user may take precedence over the zone of the device which the user is using. Thus, in the example above, when the engineering department employee uploads a document to engineering file server 103 from workstation 113a, the document may be treated as being sent from the Engineering Department zone to the Engineering Department zone (i.e., not crossing a zone boundary). However, the invention is not limited in this respect as, in some embodiments, the zone of the device may take precedence over the zone of the user using the device, and in some embodiments whether the user's zone or the device's zone takes precedence may be configured by an administrator of the organization.

As discussed above, the information protection rules may define whether and what actions are to be performed when information is transferred across a zone boundary based on the zone to which the information is being transferred, the zone from which the information is being transferred, and the classification of the information being transferred. Information may be classified in any of a variety of ways and classification of information may be performed at any of a variety of points in the information creation and sharing process. For example, classification may be performed, automatically, semi-automatically, or manually, and may be performed when the information is created, when the information is stored, when the information is transferred, and/or at any other suitable time.

For example, in some embodiments, when an application program is used to create a document (e.g., an e-mail or other document), the application program may automatically classify the document. The application program may classify the document based on any suitable criteria or criterion. For example, the application program may automatically classify the document based on the zone into which the user and/or device has been grouped or based on keywords or patterns in the document. Thus, for example, documents that include certain keywords or patterns of text may be assigned certain classifications. In some embodiments, documents may be classified by hashing the document using a hash function (e.g., SHA1 or any other suitable hash function), comparing the hash value to a set of stored hash values, and assigning a classification to the documents based on the comparison. In some embodiments, documents may be classified using fuzzy matching the employs shingling techniques to represent the fuzzy hashing of documents (or portions of documents) for similarity detection. In some embodiments, a document may be classified based on a template from which the document was created, or may be assigned a default classification associated with that application program used to create or edit the document or some other default classification. The application program may classify the document upon initial creation of the document, each time the document is saved, when the document is completed, and/or any other suitable time.

In some embodiments, instead of or in addition to the application program used to create a document performing classification, classification may be performed by an information protection agent or other software program executing on the computer used to create the document. Such a software program may perform classification of a document based on any of the criteria (or any combination of the criteria) discussed above, and may perform classification of the document at any suitable time after initial creation of the document For example, such an agent or other software program may classify documents stored on the computer as background process, may classify documents upon initiation a transfer of the documents outside of the computer, or at any other suitable point in time.

In the examples above, documents are classified on the computer on which they are created. However, the invention is not limited in this respect as, in some embodiments, a document may be classified by an entity that receives the document. For example, if a document is transferred, the device that receives the document may perform classification of the document before applying information control rules to determine, for example, whether the transfer is permitted and should be completed or is not permitted and should be dropped. For example, an e-mail client executing on a workstation may send an e-mail to an e-mail server in the organization for transmission to the intended recipients. In some embodiments, the e-mail server may perform classification of the e-mail. In addition, e-mails or other documents received from an entity external to the organization may not be classified until they are received by a device within the organization, as the external entities may not use the same information protection model to classify documents. Thus, classification may be performed on these documents after they are received within the organization. For example, an e-mail server may perform classification of e-mails received from external senders, or an internal file server may perform classification of documents uploaded from external senders.

Once the appropriate classification for a document has been determined, the classification may be stored in any of a variety of ways. In some embodiments, the classification may be embedded (e.g., as a tag or label) in the document itself. For example, the classification of an e-mail may be embedded in the e-mail header, and the classification of other types of document may be embedded in metadata included in the document.

In the examples discussed above, classification of documents is performed automatically. However, the invention is not limited in this respect, as in some embodiments, classification of documents may be performed semi-automatically, such that a classification may be assigned to a document automatically, but a user has the ability to override the automatic classification and assign a different classification to the document.

In some embodiments, policies may be defined that indicate which users are authorized to assign classification to documents and which users are allowed to override a previously-assigned classification. For example, in some embodiments, a subsequent user may be permitted to override a previously-assigned classification by an initial user, if the subsequent user is a manager or boss of the initial user. The determination as to whether the subsequent user is a manager or boss of the initial user may be made, for example, using organizational chart (org chart) information stored in the directory information of a directory server.

In some embodiments, classification of documents may be performed manually, such that users manually specify the classification that is to be assigned to each document. In such embodiments, if a document for which a classification has not been assigned is transferred across a zone boundary, it may be assigned a default classification so that the information protection rules may be applied.

Any suitable classification scheme may be used to classify documents. In some embodiments, the classifications that are available to be assigned to a document may be configured by an administrator of the organization. Examples of classifications that may be used include, “Company Confidential,” “Personal,” “Non-Confidential,” “Financial Data,” and/or any other suitable classification.

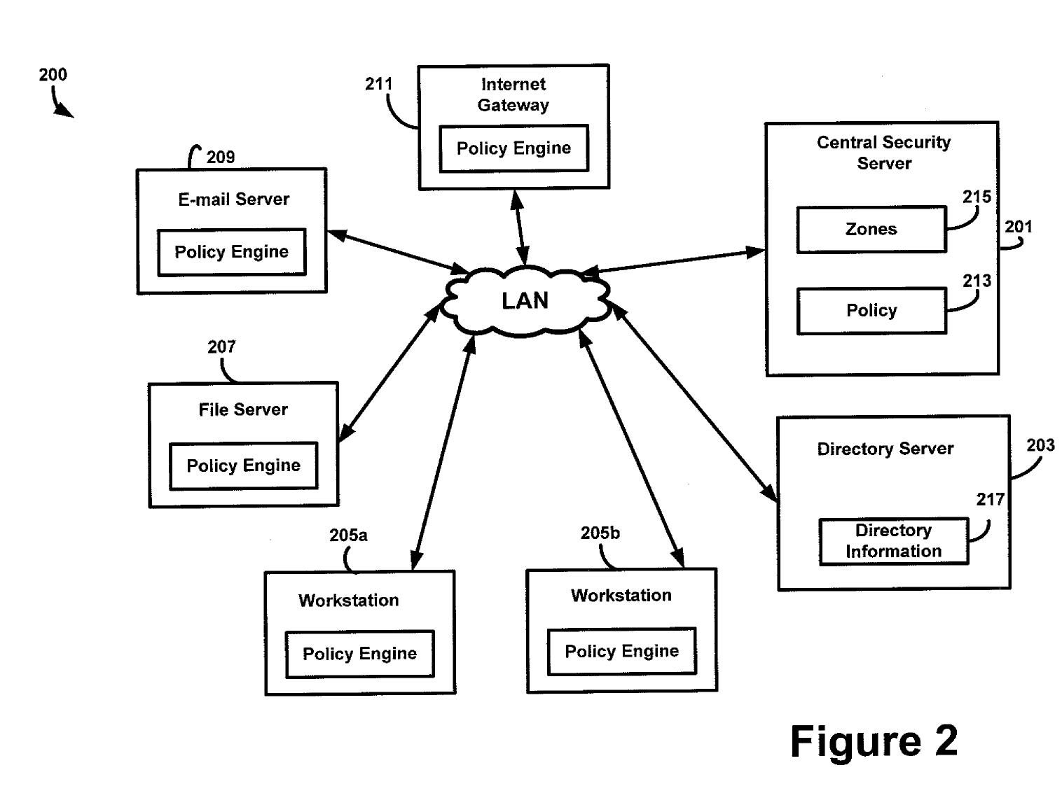

FIG. 2 is a block diagram of a computer system 200 for an organization in which information protection rules based on zones and information classification may be employed. Computer system 200 comprises a central security server 201, which stores zone information 215 and policy information 213. Zone information 215 indicates the zones that have been defined (e.g., by a network administrator) and the devices, users, and/or domains that are grouped into each of the defined zones. Policy information 213 specifies the information protection rules (e.g., that have been defined by an administrator) that are to be applied when information is transmitted across a zone boundary.

Computer system 200 may also include a directory server 203 that stores directory information 217. Directory information 217 includes information about users of and devices in the computer system. In addition, directory information may define organizational units or groups of users and devices. For example, directory information 217 may define an “Engineering Group” that includes users and/or devices in the engineering department and may define a “PR Group” that includes users and/or devices in the PR department.

In some embodiments, directory information 217 may be used to group users, devices, and/or domains into zones. For example, zone information 215 may be configured to indicate that every user or device in the “Engineering Group” is grouped into the “Engineering Department” zone and every user or device in the “PR Group” is grouped into the “PR Department” zone.

The inventors have recognized that when an entity (e.g., an organization) is an external to the organization operating computer system 200, an administrator of computer system 200 may not have access to directory information identifying the users and devices of the external organization. Thus, if it is desired to group the external organization into a zone, the domain name of the organization may be used. For example, if an external organization named “Contoso, Inc.” uses the domain name “contoso.com,” and it is desired to group this organization into a zone (e.g., a “Trusted Partner” zone), then the zone information may identify the domain name “contoso.com” as belonging to this zone. In some embodiments, directory information 217 may define a group of Trusted Partners that includes the domain names of external entities, and the zone information may indicate that all of the domain names in that group are grouped into a particular zone (e.g., the “Trusted Partner” zone).

Computer system 200 may also include a number of other devices. For example, in FIG. 2, computer system 200 includes an e-mail server 209, a file server 207, workstations 205a and 205b, and Internet gateway 211. Internet gateway 211 may serve as a gateway to the Internet for the devices in computer system 200, and the devices in computer system 200 may communicate with each other via local area network (LAN) 218.

Devices 205a, 205b, 207, 209, and 211 each include a policy engine. The policy engine on each of these devices may operate when information is received from another device or is being sent to another device to determine when the information has crossed or would, if transmitted, cross a zone boundary. If so, the policy engine may determine based on the information protection rules, whether any policy action is warranted, and may perform the policy action.

In the example of FIG. 2, each of devices 205a, 205b, 207, 209, and 211 executes a policy engine. However, the invention is not limited in this respect. That is, in some embodiments, only those devices that are at a zone boundary (e.g., devices that are capable of directly transmitting information to or receiving information from another zone) may execute a policy engine. Thus, if such embodiments were employed in the example of FIG. 2, and if all of the devices and users in computer system 200 were grouped into a single zone, then only Internet gateway 211 need execute a policy engine.

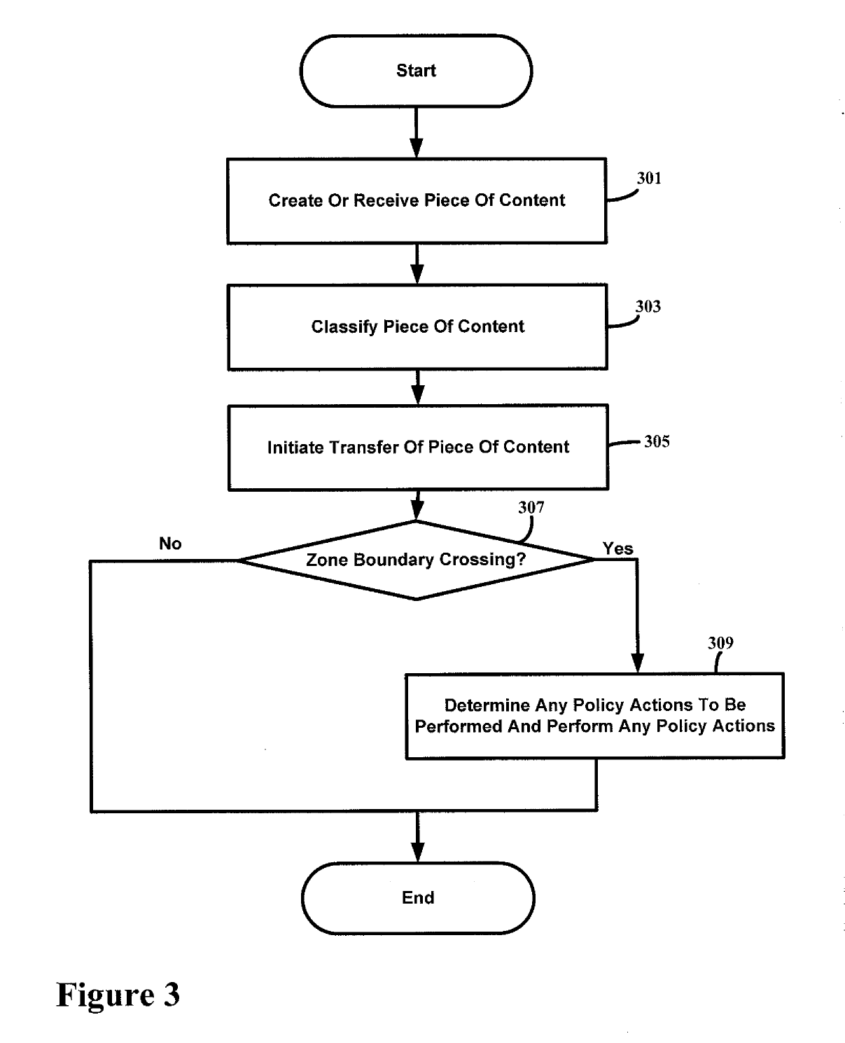

FIG. 3 shows an illustrative information protection process that may be used in a computer system such as computer system 200 to implement information protection rules. The process begins at act 301, where a piece of content (e.g., a document) is created or received. The process next continues to act 303, where the piece of content is classified and the classification for the piece of content is stored.

After act 303, the process continues to act 305, where transfer of the piece of content to another device is initiated. The process next continues to act 307, where it is determined if the transfer causes or would cause the piece of content to cross a zone boundary. Act 307 may be performed, for example, by a policy engine on the device which is initiating sending the piece of content or on another device that receives the piece of content after it has been transmitted from the device which initiated the transfer.

The policy engine may determine whether the transfer causes or would cause the information to cross a zone boundary in any of a variety of ways. For example, in some embodiments, the policy engine may communicate with the central security server 201 (which, as discussed above, stores zone information 215) to determine the zone of the device or user that initiated the transfer and the zone of the device or user that is the intended recipient of the transfer. Alternatively, in some embodiments, all or portions of this zone information may be cached locally on the device, and the policy engine may use the locally cached information to determine the zone of the device or user that initiated the transfer and the zone of the device or user that is the intended recipient. If the zone of the device or user that initiated the transfer and the zone of the device or user that is the intended recipient of the piece of content are the same, it may be determined that the transfer does not cause the piece of content to cross a zone boundary, and the process may end.

If the zone of the device or user that initiated the transfer and the zone of the device or user that is the intended recipient of the piece of content are different, it may be determined that the transfer causes or would cause the piece of content to cross a zone boundary, and the process may continue to act 309. At act 309, the policy engine may determine whether any policy actions are to be taken as a result of the intended transfer and perform the policy actions. The policy engine may determine whether any policy actions are to be taken in any suitable way. For example, the policy engine may communicate with the central security server 201 to determine the information protection rules stored in policy information 213, and may apply these rules to the transfer in question. Alternatively, in some embodiments, all or some of the rules stored in policy information 213 may be cached locally on the device, and the policy engine may use the locally cached information to determine the classification rules.

The classification rules may specify any suitable policy action based on the classification rules. For example, the policy engine may block the transfer, require encryption of the content to complete the transfer, create an audit log entry of the transfer, prompt the user for confirmation before completing the transfer, create a copy of the information desired to be transferred, send an alert to a user or an administrator notifying him or her of the transfer, and/or take any other suitable action.

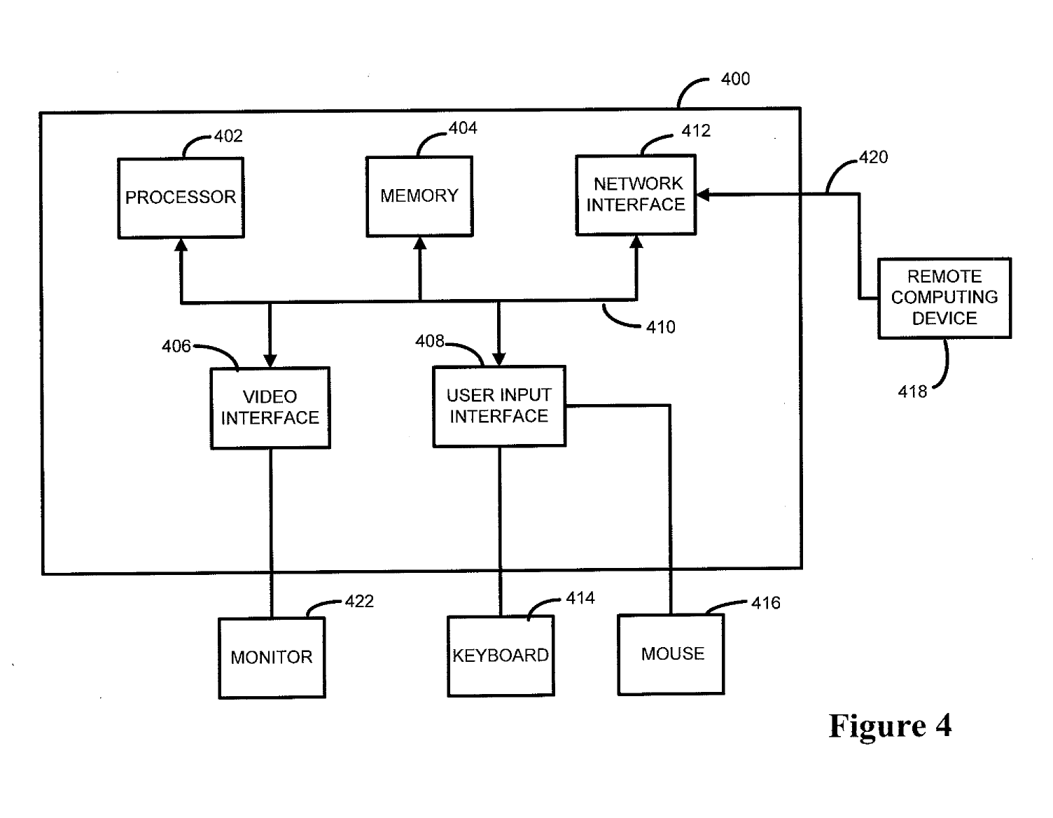

FIG. 4 shows a schematic block diagram of an illustrative computer 400 on which aspects of the invention may be implemented. Only illustrative portions of the computer 400 are identified for purposes of clarity and not to limit aspects of the invention in any way. For example, the computer 400 may include one or more additional volatile or non-volatile memories (which may also be referred to as storage media), one or more additional processors, any other user input devices, and any suitable software or other instructions that may be executed by the computer 400 so as to perform the function described herein.

In the illustrative embodiment, the computer 400 includes a system bus 410, to allow communication between a central processing unit 402 (which may include one or more hardware general purpose programmable computer processors), a tangible memory 404, a video interface 406, a user input interface 408, and a network interface 412. The network interface 412 may be connected via network connection 420 to at least one remote computing device 418. Peripherals such as a monitor 422, a keyboard 414, and a mouse 416, in addition to other user input/output devices may also be included in the computer system, as the invention is not limited in this respect.

In some embodiments, the devices illustrated and described above may be implemented as computers, such as computer 400. For example, in some embodiments, devices 201, 203, 205a, 205b, 207, 209, and 211 may each be implemented as a computer, such as computer 400. In this respect, it should be appreciated that the above-described functionality of these devices may be implemented by central processing unit 402 executing software instructions to perform this functionality, and that information described above as being stored on these devices may be stored in memory 404.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items

What is claimed is:

1. A method for information protection performed by a computer comprising at least one processor and at least one tangible memory, the computer operating in an information space comprising a plurality of zones of users, devices, and/or domains, wherein each of the plurality of zones is a logical grouping of users, devices, and/or domains, and wherein the method comprises:
in response to initiation of a transfer of information, determining whether the transfer of information would cause the information to cross a zone boundary between two of the plurality of zones;
when it is determined that the transfer would not cause the information to cross the zone boundary, permitting the transfer;
when it is determined that the transfer would cause the information to cross the zone boundary:
accessing information protection rules;
applying the information protection rules to the transfer to determine whether a policy action is to be performed; and
when it is determined the policy action is to be performed, performing the policy action.

2. The method of claim 1, wherein the act of determining whether the transfer of information would cause the information to cross a zone boundary further comprises an act of:
receiving zone information from a security server that indicates a first one of the plurality of zones into which a user or device that initiated the transfer is grouped and a second one of the plurality of zones into which a user or device that is an intended recipient of the transfer of information is grouped.

3. The method of claim 2, wherein the security server is a separate device from the computer.

4. The method of claim 2, further comprising:
determining whether the first one of the plurality of zones and the second one of the plurality of zones are the same one of the plurality of zones;
when it is determined that the first one of the plurality of zones and the second one of the plurality of zones are the same one of the plurality of zones, determining that the transfer would not cause the information to cross the zone boundary; and
when it is determined that the first one of the plurality of zones and the second one of the plurality of zones are not the same one of the plurality of zones, determining that the transfer would cause the information to cross the zone boundary.

5. The method of claim 1, wherein the act of accessing the information protection rules further comprises:
accessing the information protection rules from a security server that stores the information protection rules, wherein the security server is a separate device from the computer.

6. The method of claim 1, wherein the act of applying the information protection rules to the transfer to determine whether a policy action is to be performed further comprises:
determining a classification of the information;
determining whether the policy action is to be performed based, at least in part on the classification of the information.

7. The method of claim 6, wherein the act of determining the classification of the information further comprises:
determining the classification of the information from the content of the information.

8. The method of claim 7, wherein the content of the information directly specifies the classification.

9. The method of claim 7, wherein the content of the information does not directly specify the classification, and wherein the act of determining the classification further comprises:
identifying at least one pattern in the content;
determining the classification based on the at least one pattern.

10. The method of claim 6, where the classification of the information indicates a security level of the information.

11. The method of claim 1, wherein the act of performing the policy action further comprises:
blocking the transfer of information.

12. The method of claim 1, wherein the act of performing the policy action further comprises:
encrypting the information.

13. The method of claim 1, wherein the act of performing the policy action further comprises at least one of:
allowing the transfer of information;
logging the transfer of information;
sending an alert of the transfer of information; or
creating a copy of the information.

14. The method of claim 1, wherein the act of performing the policy action further comprises:
prompting a user that initiated the transfer of information to confirm his intent to transfer the information.

15. At least one computer readable medium encoded with instructions that when executed on a computer comprising at least one processor and at least one tangible memory, perform a method in an information space comprising a plurality of zones of users, device, and/or domains, wherein each of the plurality of zones is a logical grouping of users, devices, and/or domains, wherein the computer is grouped into one of the plurality of zones, the method comprising:
creating a document at the computer;
automatically determining a first classification for the document;
embedding information identifying the determined first classification into the document;
receiving user input identifying a second classification for the document;
in response to the user input, overriding the first classification with the second classification by removing the information identifying the first classification from the document and embedding information identifying the second classification into the document.

16. The at least one computer-readable medium of claim 15, wherein the act of automatically determining a first classification for the document comprises determining the first classification based, at least in part, on the one of the plurality of zones into which the computer is grouped.

17. The at least one computer-readable medium of claim 15, wherein the act of automatically determining a first classification for the document comprises determining the first classification based, at least in part, on the one of the plurality of zones into which a user of the computer is grouped.

18. The at least one computer-readable medium of claim 15, wherein the act of automatically determining a first classification for the document comprises determining the first classification based, at least in part, on the content of the document.

19. The at least one computer-readable medium of claim 15, wherein the act of creating the document further comprises creating the document from a template, and wherein the act of automatically determining a first classification for the document further comprises determining the first classification based, at least in part, on the template.

20. A computer in a computer system comprising:
at least one tangible memory; and
at least one hardware processor that executes processor-executable instructions to:
in response to user input of first information that groups users, devices, and/or domains into logical zones, storing the first information in the at least one tangible memory; and
in response to user input of second information specifying information protection rules to be applied in response to initiation of a transfer of information that would cause the information to cross a boundary between logical zones, storing the second information in the at least one tangible memory.
